(19) United States
(12) Patent Application Publication
(10) Pub. No.: US 2008/0057161 A1
(43) Pub. Date: Mar. 6, 2008

(54) Functionalized coffee

(76) Inventors: Donald Brucker, La Jolla, CA (US); Michael Sweeney, Houston, TX (US); Thomas Breen, San Juan Capistrano, CA (US)

Correspondence Address: FISH & RICHARDSON, PC, P.O. BOX 1022, MINNEAPOLIS, MN, 55440-1022, US

(21) Appl. No.: 11/982,219

(22) Filed: Oct. 31, 2007

Related U.S. Application Data
(62) Division of application No. 10/841,958, filed on May 7, 2004.
(60) Provisional application No. 60/493,042, filed on Aug. 5, 2003.
(60) Provisional application No. 60/507,585, filed on Sep. 30, 2003.
(60) Provisional application No. 60/532,760, filed on Dec. 24, 2003.
(60) Provisional application No. 60/561,767, filed on Apr. 12, 2004.
(60) Provisional application No. 60/563,644, filed on Apr. 19, 2004.

(51) Int. Cl. A23F 5/00; A23L 1/30; A23L 1/302; A23L 1/303

(52) U.S. Cl. 426/73; 426/595; 426/72

(57) ABSTRACT

The disclosure provides a functionalized coffee composition comprising one or more non-vitamin, non-mineral functional additives. In some aspects, vitamins and/or minerals may be provided in the functionalized coffee compositions. The disclosure also includes methods of making a functionalized coffee composition and coffee beverages made therefrom.

### CROSS REFERENCE TO RELATED APPLICATIONS

This application is a divisional of co-pending U.S. patent application Ser. No. 10/841,958, filed May 7, 2004, which claims priority under 35 U.S.C. §119 to the following U.S. Provisional Applications: U.S. Provisional Ser. No. 60/493,042, filed Aug. 5, 2003; U.S. Provisional Ser. No. 60/507,585, filed Sep. 30, 2003; U.S. Provisional Ser. No. 60/532,760, filed Dec. 24, 2003; U.S. Provisional Ser. No. 60/561,767, filed Apr. 12, 2004; and U.S. Provisional Ser. No. 60/563,644, filed Apr. 19, 2004, the disclosures of which are incorporated herein by reference in their entireties.

### TECHNICAL FIELD

This disclosure relates to a coffee composition and a coffee beverage or drink. More particularly, the disclosure relates to methods of making a functionalized coffee and functionalized coffee compositions as well as caffeinated beverages and coffee drinks.

### BACKGROUND

Caffeinated beverages have been growing in popularity over the decades. Caffeine itself is a stimulant that increases metabolism and activity. Common additions to brewed caffeinated beverages include milk or creamers, additional caffeine, sugar and other flavorants. However, caffeinated beverages generally are not used for delivery of functional additives such as minerals, vitamins, and other additives that promote the health and welfare of consumers.

In recent years there has been an increasing awareness of the benefits attributable to a diet rich in essential nutrients, vitamins and other beneficial agents.

### SUMMARY

The disclosure provides a composition, comprising roasted coffee beans and one or more non-vitamin, non-mineral functional additives. In one aspect, the one or more non-vitamin, non-mineral functional additives are selected from the group consisting of an amino acid, MSM, green tea or green tea extract, DMAE, alpha-lipoic acid, lutein preparations, white willow bark preparations, ginger preparations, colostrum, a phytosterol (e.g., beta-sitosterol), a phytostanol, passion flower preparations, ginseng preparations, sarsaparilla preparations, bayberry root preparations, echinacea powder, burdock root preparations, goldenseal root preparations, kelp preparations, hyssop preparations, milk thistle preparations, astragalus preparations, black-currant oil, cordyceps preparations, quercetin (a flavonoid), stinging nettle preparations, and tumeric preparations. The composition may further include one or more vitamins and/or minerals.

The disclosure also provides a composition, comprising ground coffee from roasted coffee beans and one or more non-vitamin, non-mineral functional additives. In one aspect, the one or more non-vitamin, non-mineral functional additives are selected from the group consisting of an amino acid, MSM, green tea or green tea extract, DMAE, alpha-lipoic acid, lutein preparations, white willow bark preparations, ginger preparations, colostrum, a phytosterol (e.g., beta-sitosterol), a phytostanol, passion flower preparations, ginseng preparations, sarsaparilla preparations, bayberry root preparations, echinacea powder, burdock root preparations, goldenseal root preparations, kelp preparations, hyssop preparations, milk thistle preparations, astragalus preparations, black-currant oil, cordyceps preparations, quercetin (a flavonoid), stinging nettle preparations, and tumeric preparations. The composition may further include one or more vitamins and/or minerals.

Also provided by the disclosure is a method for making a functionalized coffee. The method includes contacting whole roasted coffee beans with a composition comprising one or more non-vitamin, non-mineral functional additives. In one aspect, the one or more non-vitamin, non-mineral functional additives are selected from the group consisting of an amino acid, MSM, green tea or green tea extract, DMAE, alpha-lipoic acid, lutein preparations, white willow bark preparations, ginger preparations, colostrum, a phytosterol (e.g., beta-sitosterol), a phytostanol, passion flower preparations, ginseng preparations, sarsaparilla preparations, bayberry root preparations, echinacea powder, burdock root preparations, goldenseal root preparations, kelp preparations, hyssop preparations, milk thistle preparations, astragalus preparations, black-currant oil, cordyceps preparations, quercetin (a flavonoid), stinging nettle preparations, and tumeric preparations. The composition may further include one or more vitamins and/or minerals.

The disclosure further provides a method, comprising identifying one or more non-vitamin, non-mineral functional additives; adding the one or more non-vitamin, non-mineral functional additives to coffee grounds; and mixing the one or more non-vitamin, non-mineral functional additives with the coffee grounds to create a functional coffee. In one aspect, the one or more non-vitamin, non-mineral functional additives are selected from the group consisting of an amino acid, MSM, green tea or green tea extract, DMAE, alpha-lipoic acid, lutein preparations, white willow bark preparations, ginger preparations, colostrum, a phytosterol (e.g., beta-sitosterol), a phytostanol, passion flower preparations, ginseng preparations, sarsaparilla preparations, bayberry root preparations, echinacea powder, burdock root preparations, goldenseal root preparations, kelp preparations, hyssop preparations, milk thistle preparations, astragalus preparations, black-currant oil, cordyceps preparations, quercetin (a flavonoid), stinging nettle preparations, and tumeric preparations. The composition may further include one or more vitamins and/or minerals.

The details of one or more embodiments of the disclosure are set forth in the description below. Other features, objects, and advantages of the disclosure will be apparent from the description, and from the claims.

### DETAILED DESCRIPTION

The disclosure provides methods and compositions comprising coffee beans that have been roasted, but prior to brewing are modified by the addition of one or more functional additives, non-vitamin functional additives, non-mineral functional additives, or non-vitamin and non-mineral functional additives. The disclosure also provides methods and compositions whereby ground coffee, prior to brewing or extraction, is modified by the addition of one or more functional additives, non-vitamin functional additives, non-mineral functional additives, or non-vitamin and non-mineral functional additives. The compositions provide beneficial qualities to brewed coffee, caffeinated beverages or drinks as well as health benefits to the consumer.

Furthermore, the addition of functional additives to coffee bean and coffee grounds allows for the ready preparation of a healthy caffeinated beverage or drink. Such healthy beverages/drinks can be used to deliver functional additives to a subject suffering from any number of ailments. There is some evidence that coffee promotes the uptake of certain agents possibly due in part to the acidity of the coffee and/or the increased metabolism caused by caffeine.

The disclosure provides compositions (including dried ground coffee, whole roasted coffee bean, and caffeinated beverages/drinks) containing functional additives at an amount from approximately 0.01% to 20% by dry weight.

Coffee is a drink made by percolation, infusion, or decoction from the roasted and ground or pounded seeds of a coffee tree. Coffee is noted for its high caffeine content. Caffeine is a bitter compound C₈H₁₀N₄O₂ found in many herbal products in coffee, tea, and kola nuts and used medicinally as a stimulant and diuretic-caffeinic.

Functional additives include nutraceuticals and related herbal remedies as described more fully herein. For example, functional additives for use in the methods and compositions of the disclosure include, but are not limited to, vitamins, minerals, methyl-sulfonyl-methane (MSM), green tea and green tea extract, dimethylaminoethanol (DMAE), alpha-lipoic acid, lutein, white willow bark, ginger, amino acids, chromium picolinate, and vanadium. Non-vitamin, non-mineral functional additives include, for example, nutraceuticals that are not considered vitamins, and nutraceuticals that are not considered minerals. For example, a non-vitamin, non-mineral functional additive includes, without limitation, amino acids, MSM, green tea and green tea extract, DMAE, alpha-lipoic acid, lutein preparations, white willow bark preparations, ginger preparations, colostrum, a phytosterol (e.g., beta-sitosterol), a phytostanol, passion flower preparations, ginseng preparations, sarsaparilla preparations, bayberry root preparations, echinacea powder, burdock root preparations, goldenseal root preparations, kelp preparations, hyssop preparations, milk thistle preparations, astragalus preparations, black-currant oil, cordyceps preparations, quercetin (a flavonoid), stinging nettle preparations, and tumeric preparations.

Non-limiting exemplary herbals and herbal derivatives for use in the disclosure include agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, cascara sagrada, catnip, celery, centaury, chamomile, chaparral, chickweed, chicory, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, garlic, gentian, ginger, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. Johnswort, sarsaparilla, sassafras, saw palmetto, scullcap, senega, senna, shepherd's purse, slippery elm, spearmint, spikenard, squawvine, stillingia, strawberry, taheebo, thyme, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca and combinations thereof. Herbal derivatives, as used herein, refers to herbal extracts, and substances derived from plants and plant parts, such as leaves, flowers and roots, without limitation.

The functional additives in combination with coffee beans and/or coffee grounds provide a suitable method of delivery of the additive to a subject. The functional additives provided by the disclosure provide beneficial qualities to a subject that consumes a caffeinated beverage/drink obtained by extraction of the coffee bean or coffee grounds comprising the functional additive. The functionalized coffee of the disclosure can be used, for example, to improve a subject's memory, reduce joint pain and/or inflammation, reduce oxidative damage, reduce allergy symptoms, improve weight loss and/or reduce weight gain, reduce pain (e.g., pain associated with inflammation), reduce stomach upset, reduce motion sickness, improve energy and metabolism, promote smoking cessation, and improve cholesterol levels (i.e., lower cholesterol). The disclosure provides certain formulations useful to effect a subjects health, however, other formulations will be readily apparent from the description and the agents described below.

In one aspect of the disclosure, kelp (fucus vesiculosus) preparations are added to roasted coffee and/or ground coffee. Kelp is an excellent source of minerals from the sea, including iodine, which is important for the thyroid to function properly. Studies regarding diets including kelp have determined a link to a lower breast cancer rate, and a healthier hormonal balance. Kelp is a source of vitamins A, B₁, B₂, C, D and E, plus amino acids. It contains algin, which will absorb toxins from the digestive tract. Bladderwrack kelp is one of the richest natural sources of approximately 30 trace elements and major minerals. It regulates the thyroid function and may be helpful in reducing obesity where it is associated with thyroid trouble. Bladderwrack kelp is also a metabolic stimulant. This is important to keep tissue in the body, healthy. Typical parts of a kelp plant that can be used in the methods and compositions of the disclosure include the dried thallus and the fresh thallus of the bladderwrack. Some thallus ends look grainy and it is here that the reproductive organs of the plant are found. The fructifications consisting of 3 cm long ovoid receptacles are found in the tips of these thalli and are either cordate or ovately flattened with grainy bladders. The bladderwrack plant is often over 1 m long, olive green when fresh, black brown when dry. The stem of the thallus is flat, repeatedly bifurcated and has a midrib along the whole length. Beside this midrib there are often scattered pores and numerous air-filled bladders. The plant is found on the North Sea Coast, the Western Baltic Coast, and on the Atlantic and Pacific Coasts. Bladderwrack consists of the dried thallus of Fucus vesiculosus, of Ascophyllum nodosum Le Jolis, or of both species, as well as preparations of same. Other names associated with Bladderwrack include Seawrack, Kelpware, Black-tang, Bladder Fucus, Cutweed, Fucus, Quercus marina, Sea-Wrack, and Kelp-Ware.

Sources of kelp are known in the art. For example, kelp is obtained by picking fresh kelp and allowing it to dry to a stage where it can be finely ground or otherwise comminuted. The dried kelp (or part thereof) particles are dispersed or dissolved in an aqueous media to allow for spray coating of roast coffee beans or for use in fluidized bed methods. Alternatively, finely comminuted preparations are dispersed (substantially homogenously) in ground coffee preparations. The ground particle size useful in the compositions of the disclosure is about 0.1-0.5 mm, or 0.2-1 mm, but is typically about 0.3-0.7 mm. Alternatively, an extract of kelp may also be prepared by steam distillation, expression (hard pressing), or maceration. A tincture extract can be diluted as appropriate to obtain the desired concentration and/or therapeutic effect. Other methods of preparing kelp can be found in, “The Homeopathic Pharmacopoeia,” Official Compendium, Jul. 1, 1992, Pharmacopoeia Convention of the American Institute of Homeopathy (Publishers), Falls Church, Va., incorporated herein by reference.

In another aspect, a coffee composition comprising roast coffee beans (or ground coffee) and phytosterol and/or phytostanol is provided. Such compositions are useful in reducing the levels of “bad” cholesterol such as low density lipoproteins (LDLs) in the blood of the subject.

A good source of a phytosterol (e.g., beta-sitosterol) and phytostanol is corn fiber oil. Corn fiber oil includes phytosterols esterified with either fatty acids or phenolic acids, such as ferulic acid, an antioxidant. Furthermore corn fiber oil also contains a high level of sitostanol in the ferulic acid ester fraction. Corn fiber oil is commercially available under the trade name AMAIZING OIL. Because corn fiber oil is obtained in fluid form it is suitable for spray coating and fluidized bed treatment of roasted coffee beans and ground coffee.

In another aspect of the disclosure a coffee composition comprising roast coffee beans (or ground coffee) and amino acid(s) are provided. Such compositions are useful increasing energy, promoting immune system function, improving metabolism, and modulating neural activity.

Amino acids include alanine, arginine, asparagine, aspartic acid, cysteine, glutamine, glutamic acid, glycine, histidine, isoleucine, leucine, lysine, methionine, phenylalanine, proline, serine, theanine, tryptophan, tyrosine and valine. Sources of such amino acids for use in the methods and compositions of the disclosure include soy protein hydrolyzate with bound phospholipids, lecithin. In particular, L-glutamine and glycine, and branched-chain amino acids such as L-leucine, L-valine and L-isoleucine are useful in the methods and compositions of the disclosure. For example, L-glutamine is essential for the proper functioning of the brain. It is an energy source in the brain and a mediator of glutamic acid and GABA activity. L-glutamine is also vital to immune system functioning and is required for cellular replication in the immune system. However, the majority of L-glutamine is made in the muscles. Glycine, for example, is an important precursor for the production of protein, DNA, phospholipids, collagen, and creatine. It is also a precursor in the release of energy. It is necessary for the proper functioning of the central nervous system and is an inhibitory neurotransmitter. Similarly, L-leucine is an essential amino acid found in proteins, is important in energy production during exercise. According to estimates, up to 90 percent of dietary L-leucine may be used for energy in existing muscles. This makes L-leucine a very limiting amino acid. Thus, it may be important to supplement the amounts of L-leucine to compensate for the loss during exercise. L-leucine has been shown to help spare muscle tissue, maintain nitrogen balance, and promote muscle growth and healing. L-valine is involved in tissue repair, nitrogen balance, and muscle metabolism. L-valine regulates how the body uses protein and plays a unique role in protein metabolism in muscles. Intense physical exercise produces a rapid excretion of nitrogen, which causes a decrease in muscle protein synthesis. L-valine limits this decrease. L-isoleucine is an integral part of muscle tissue. L-isoleucine is found in proteins and is needed for the formation of hemoglobin. It is involved in the regulation of blood sugar and is metabolized for energy in muscle tissue during exercise. Intense physical exercise produces a rapid excretion of nitrogen, which causes a decrease in muscle protein synthesis. L-isoleucine limits this decrease. L-Arginine is an amino acid suggested to be associated with improved sexual function when used as a supplement. Similarly, L-histidine has also been suggested as providing improved sexual health including more intense orgasms when used as a supplement.

Amino acids can be obtained in powder or liquid form and thus are easily combined with roast coffee beans and/or coffee grounds by the methods described herein.

Excessive concentrations of various forms of oxygen and of free radicals can damage to living systems, including the peroxidation of membrane lipids, the hydroxylation of nucleic acid bases, and the oxidation of sulfhydryl groups and of other sensitive moieties in proteins. If uncontrolled, mutations and cellular death result.

As mentioned above, the coffee compositions of the disclosure can assist in reducing oxidative damage by free radicals. Free radicals, particularly free radicals derived from molecular oxygen, have been associated with a number of diseases and disorders (Zimmermen J. J. (1991) Chest 100: 189S). Some of the disease and disorders associated with oxygen free radicals include pulmonary oxygen toxicity, adult respiratory distress syndrome (ARDS), bronchopulmonary dysplasia, sepsis syndrome, and a variety of ischemia-reperfusion syndromes, including myocardial infarction, stroke, cardiopulmonary bypass, organ transplantation, necrotizing enterocolitis, acute renal tubular necrosis, and other disease.

Many free radical reactions are highly damaging to cellular components; they crosslink proteins, mutagenize DNA, and peroxidize lipids. Once formed, free radicals can interact to produce other free radicals and non-radical oxidants such as singlet oxygen and peroxides. Degradation of some of the products of free radical reactions can also generate potentially damaging chemical species.

Green tea leaf extract has been renowned as the herbal healer for over 4000 years. It is one of the best sources of polyphenols—naturally occurring plant chemicals that have amazing antioxidant properties. For example, green tea catechins neutralize dietary carcinogens such as nitrosamine and aflatoxin.

Green tea contains volatile oils, vitamins, and minerals, but the active constituents are polyphenols, particularly the catechins called epigallocatechin gallate (EGCG). The polyphenols are believed to be responsible for most of green tea's roles in promoting good health. Research demonstrates that green tea guards against cardiovascular disease in many ways. Green tea lowers total cholesterol levels and improves the cholesterol profile (the ratio of LDL cholesterol to HDL cholesterol), reduces platelet aggregation, and lowers blood pressure. The polyphenols in green tea have also been shown to lessen the risk of cancers of several sites, stimulates the production of several immune system cells, and have anti-bacterial properties even against the bacteria that cause dental plaque. Green tea treatment appears to reduce heart disease risk factors.

Green Tree extracts can be added in a powdered form to roasted coffee beans and/or ground coffee in sufficient quantity to have beneficial health qualities without significantly affecting the taste, aroma, and other qualities of the coffee. The type of coffee used can be either caffeinated or de-caffeinated. For example, in one aspect the green tea extract (95% pure) comprises about 5.4% by weight of a ground coffee composition (e.g., 2 grams green tea extract in 37 gram bag of composition).

Green tea extract is a natural compound containing tea polyphenols. Green tea is steamed, baked or pan heated to prevent oxidation and thus, the leaves remain green.

Method of green tea extract formulation:

| | |
|---|---|
| Use part | Green Tea Leaf |
| Solvent used in Extraction/type | Ethyl Acetate and Hydro-alcohol |
| | extraction |
| Method of Manufacturing | Water/Hydro-alcohol/Ethyl Acetate |
| | Extraction and Spray dry |
| Method of Analysis | UV-VIS & HPLC |

Other antioxidant agents that can be used in formulations with coffee beans and/or ground coffee include, for example, glutathione-like substances as well as NAD and derivatives thereof (e.g., NADH). NAD and NAD derivatives include quinolinic acid; quinolinic acid ribonucleotide; nicotinamide; nicotinic acid; nicotinic acid ribonucleotide; nicotinic acid ribonucleotide, reduced form; nicotinamide ribonucleotide; nicotinamide ribonucleotide, reduced form; nicotinic acid adenine dinucleotide; nicotinic acid adenine dinucleotide, reduced form; nicotinamide adenine dinucleotide (NAD); nicotinamide adenine dinucleotide phosphate (NADP); nicotinamide adenine dinucleotide, reduced form (NADH); and nicotinamide adenine dinucleotide phosphate, reduced form (NADPH) and pharmaceutically acceptable salts thereof. All of these chemicals are commercially available or are generally known. Typically the NAD related molecule is nicotinamide or nicotinic acid, more typically nicotinamide. Pharmaceutically acceptable salts are also included and can be derived from a variety of organic and inorganic counter salts well known in the art and include, by way of example only, sodium, potassium, calcium magnesium, ammonium, tetralkylammonium and the like.

In another aspect, the disclosure provides a roast coffee bean and/or ground coffee composition comprising chromium picolinate. This composition finds use in reducing weight gain and/or promoting weight loss, and finds beneficial use in affecting diabetes. Chromium picolinate helps control blood sugar and aids in insulin production. Vanadium has some properties similar to that of chromium.

The disclosure provides a composition comprising coffee beans or ground coffee (i.e., post roasting of the coffee beans) prior to brewing combined with one or more functional food additives. In one aspect the functional food additives are vanadium and/or chromium picolinate.

Chromium is a nutritionally essential trace element. The necessity of chromium in the diet was established in 1959 by Schwartz, as cited in Present Knowledge in Nutrition, page 571, fifth edition (1984, the Nutrition Foundation, Washington, D.C.). Chromium depletion is characterized by a disruption in glucose, lipid and protein metabolism and by a shortened lifespan. Chromium is essential for optimal insulin activity in all known insulin-dependent systems (Boyle et al., Southern Med. J. 70:1449-1453, 1977). Insufficient dietary chromium has been linked to both mature-onset diabetes and to cardiovascular disease.

The principle energy sources for the body are glucose and fatty acids. Chromium depletion results in biologically ineffective insulin and compromised glucose metabolism. Under these conditions, the body must rely primarily on lipid metabolism to meet its energy requirements, resulting in the production of excessive amounts of acetyl-CoA and ketone bodies. Some of the documented acetyl-CoA is converted to increased cholesterol biosynthesis, resulting in hypercholesterolemia. Diabetes mellitus is characterized in large part by glycosuria, hypercholesterolemia, and often ketoacidosis. The accelerated atherosclerotic process seen in diabetics is associated with hypercholesterolemia.

Dietary supplementation of chromium to normal individuals has been reported to lead to improvements in glucose tolerance, serum lipid concentrations, including high-density lipoprotein cholesterol, insulin and insulin binding (Anderson, Clin. Psychol. Biochem. 4:31-41, 1986). Supplemental chromium in the trivalent form, e.g. chromic chloride, is associated with improvements of risk factors associated with adult-onset (Type II) diabetes and cardiovascular disease.

Chromium functions as a cofactor for insulin. It binds to the insulin receptor and potentiates many of its functions. These functions include, but are not limited to, the regulation of carbohydrate and lipid metabolism. (Present Knowledge in Nutrition, supra, at p. 573-577). The introduction of inorganic chromium compounds into individuals is not particularly beneficial. Chromium must be converted endogenously into an organic complex or must be consumed as a biologically active molecule. Only about 0.5% of ingested inorganic chromium is assimilated into the body (Recommended Daily Allowances, Ninth Revised Edition, The National Academy of Sciences, page 160, 1980). Only 1-2% of most organic compounds are assimilated into the body. U.S. Pat. No. Re. 33,988 discloses that when selected essential metals, including chromium, are administered to mammals as exogenously synthesized coordination complexes of picolinic acid, they are directly available for absorption without competition from other metals.

Nicotinic acid and picolinic acid form coordination complexes with monovalent, divalent and trivalent metal ions and facilitate the absorption of these metals by transporting them across intestinal cells and into the bloodstream. Chromium absorption in rats following oral administration of CrCl₃ was facilitated by the non-steroidal anti-inflammatory drugs (NSAIDs) aspirin and indomethacin (Davis et al., J. Nutrition Res. 15:202-210, 1995; Kamath et al., J. Nutrition 127:478-482, 1997). These drugs inhibit the enzyme cyclooxygenase which converts arachidonic acid to various prostaglandins, resulting in inhibition of intestinal mucus formation and lowering of intestinal pH which facilitates chromium absorption.

Chromium picolinate is typically provided in a tablet, capsule or pill to be taken with meals. However, it will be recognized that the administration of tablets and pills is more difficult than drinking a beverage. Furthermore, coffee (caffeic acid) is an acidic compound that when brewed and ingested reduces the pH of the stomach and the intestine thereby increasing chromium uptake.

The combination of chromium picolinate and related compounds with a coffee composition for brewing and in caffeinated beverages/drinks facilitate absorption of chromium and other endogenous or exogenous metals, for use in lowering blood glucose levels, serum lipid levels and increasing lean body mass.

In yet another aspect, the disclosure provides roast coffee beans and/or coffee grounds and White Willow bark preparations. A coffee bean and/or coffee ground preparation comprising White Willow bark finds use in treating inflammation and aches and pains (e.g., associated with arthritis). White willow bark (a member of the Sialix sp.), also known as natural aspirin, has been used in the treatment of aches and pains. An active ingredient in the white willow bark is salicin, which is converted by the body to acetylsalicylic acid, or aspirin. Although white willow bark is believed to act in a manner similar to aspirin by blocking prostaglandin synthesis, it is efficacious at a lower blood level than aspirin. Recent studies have reported a peak plasma level of 10 mM/L following administration of 1,360 mg extract containing 240 mg salicin. This plasma level is below that of 130 mM/L that occurs following the administration of 500 mg aspirin, a dose common for analgesic and antipyretic activity (see, Schmid et al. Eur J Clin Pharmacol. 57(5):387-91, 2001). In addition, sodium salicylates may act by inhibiting the function of neutrophils, the most abundant cell associated with inflammation. Moreover, salicylates that lack an acetyl group, such as those present in white willow bark, do not inhibit aggregation of platelets at physiologically relevant concentrations (see, Krivoy et al., Planta Med. 67(3):209-12, 2001).

White Willow Bark may be dried and ground. The ground bark may then be dispersed or dissolved in a solvent and used to spray coffee beans or used in a fluidized bed system. Alternatively, the dried and ground bark preparation may be combined with ground coffee beans and mixed to a substantially homogenous mixture. Typically the formulation is adjusted to contain 15% salicin. White willow bark is typically administered at a dose of up to 400 mg/day, with typical doses ranging from 60-300 mg of salicin/day. A standard recommended starting dose is from 60-120 mg/day. When thoroughly mixed and dispersed and/or dissolved in the aqueous medium of the disclosure the white willow bark will commonly be present at a concentration of about 0.001-2.0% (e.g., about 0.05%), but is typically about 0.01-0.35% by weight (e.g., about 0.07%).

In yet another aspect, the disclosure provides roast coffee beans and/or coffee grounds and methyl-sulfonyl-methane (MSM) preparations. A coffee bean and/or coffee ground preparation comprising MSM finds use in treating aches and pains associated with joint damage (e.g., associated with arthritis). Methyl-sulfonyl-methane (MSM) or dimethyl sulfone can also be included in the methods and compositions of the disclosure. Methyl-sulfonyl-methane is essentially DMSO with an extra oxygen molecule. In the body, MSM gives up its sulfur to form methionine and cysteine for connective tissue. It is this aspect of the molecule that lends itself to treating or regenerating cartilage and other connective tissue ailments associated with, for example, inflammatory diseases such as arthritis. MSM is anti-inflammatory and analgesic and useful for muscle soreness and cramps, prevents cartilage degeneration and improves joint flexibility. The therapeutic dosage range for MSM is 2-10 grams orally per day. The recommended topical dosage range is 1-5 grams. In the disclosure, MSM is present in the coffee compositions at an amount from 0.01-0.5% of the total weight of the composition (e.g., 0.1% by weight). MSM is a compound normally found in many foods including cow's milk, meat, fruits, and vegetables. For example, in one aspect MSM comprises about 12.1% by weight of a ground coffee composition (e.g., 4.5 grams MSM in 37 gram bag of composition).

In another embodiment, the disclosure provides roast coffee beans and/or coffee grounds and glucosamine preparations. A coffee bean and/or coffee ground preparation comprising glucosamine finds use in treating inflammation and aches and pains (e.g., associated with arthritis). Glucosamine, a natural sugar synthesized by the body and present in some foods, is a component glycosaminoglycans and proteoglycans, two essential components of cartilage. Glycosamino-glycans and proteoglycans are essential in maintaining the cushion properties of cartilage. If the body does not make sufficient amounts of these carbohydrates, the cartilage degenerates, cracks and wears away resulting in a loss of cushioning between the bones. Accordingly, the methods and compositions of the disclosure may include such carbohydrate molecules in order to assist in the maintenance and/or regeneration of cartilage. Glucosamine is typically administered at a dose of up to 3,000 mg/day, with a typical dose ranging from 1,000-2,000 mg/day. The disclosure provides compositions and methods that utilize a dose of about 0.01-0.9% glucosamine by weight of the composition.

Similarly, chondroitin sulfate, another carbohydrate that is essential to the maintenance of cartilage, tendons, and other connective tissues, has been shown to be beneficial in the treatment of arthritis. Evidence suggests that chondroitin may inhibit the enzymes that break down cartilage in joints, and/or increase the amount of hyaluronic acid in the joints (a protective fluid that keeps joints lubricated). The disclosure provides compositions and methods that utilize about 0.01-0.9% chondroitin sulfate by weight of the composition.

In another aspect of the disclosure the anti-inflammatory activity of Tumeric (Curcuma Ionga) may reduce swelling in arthritic joints. Tumeric works by inhibiting platelet aggregation and cyclooxygenase and lipoxygenase enzymes that trigger the formation of inflammatory mediators (e.g., prostaglandins). Dosage should not exceed 100 mg/day dry, with lower doses if other blood thinning agents are being taken. For example, Tumeric would be present in a coffee composition of the disclosure at about 0.01-0.5% by weight. As with many herbs, extracts of dried Tumeric may be prepared.

Dimethylaminoethanol (DMAE) can be prepared in the roast coffee beans and/or coffee grounds compositions of the disclosure. A coffee bean and/or coffee ground preparation comprising DMAE finds use in treating certain neurological disorders as well as stimulating memory and brain activity. Because it steps up production of brain chemicals essential for short-term memory, concentration, and learning capacity, DMAE may aid in the treatment of ADHD and other disorders affecting the brain and central nervous system.

DMAE is sometimes referred to as a “cholinergic” because it is thought to increase levels of the neurotransmitter acetylcholine, one of the chemicals in the brain that enhances mental powers. “Cholinergic” drugs, such as tacrine (Cognex), are used to treat the dementia of Alzheimer's disease.

Cholinergic drugs are also sometimes prescribed to stabilize the debilitating movements brought on by tardive dyskinesia, a side effect of the antipsychotic drugs used to treat schizophrenia, and Huntington's chorea, an inherited condition that also causes memory loss.

Specifically, DMAE may help to relieve the inattention, impulsivity, and hyperactivity of attention deficit hyperactivity disorder (ADHD). Although ADHD has long been recognized as a cause of disruptive behavior and learning difficulties in school-age children, doctors are increasingly coming to recognize it as a cause of problems in adults as well.

DMAE may also slow the progressive dementia of Alzheimer's disease. The severe and progressive memory loss of Alzheimer's disease is due in part to the loss of brain cells that produce acetylcholine, a key chemical messenger for enhancing communication between brain cells. Acetylcholine is also essential for learning and memory. In fact, it's for these reasons that doctors routinely prescribe drugs that boost levels of acetylcholine, such as tacrine (Cognex), donepezil (Aricept), rivasatigmine (Exelon), and galantamine (Reminyl).

In animal studies, DMAE supplements have led to significant improvements in short-term memory, possibly due to cholinergic effects. A number of small studies indicate that DMAE may have similar benefits for people with Alzheimer's.

The possible memory-boosting effects of DMAE may help with the ordinary memory lapses that occur with normal aging. Many nutritionally oriented physicians prescribe DMAE along with another memory enhancer, the dietary supplement phosphatidylcholine. Some people who have tried DMAE report better memory (especially short-term memory), as well as improved concentration, focus, mental clarity, and sleep.

In one aspect of the disclosure, DMAE comprises about 0.81% by weight of a ground coffee composition (e.g., 300 mg DMAE in 37 gram bag of composition).

The disclosure also provides roast coffee beans and/or coffee grounds and ginger preparations. A coffee bean and/or coffee ground preparation comprising ginger finds use in treating stomach upset (e.g., associated with morning sickness) and motion sickness. European studies looking at ginger's potential to reduce motion sickness reported positive results. Ginger is believe to reduce nausea by increasing digestive fluids and absorbing and neutralizing toxins and stomach acid. Ginger has also been shown to increase bile secretion as well as the action and tone of the bowel. There is some evidence that suggest that ginger may also reduce the “stickiness” of blood platelets and may thereby reduce the risk of atherosclerosis. Ginger is typically prepared from and used as a fresh root, dried root, tincture and the like.

Milk thistle extract can also be used in the compositions of the disclosure. Compositions comprising coffee beans and/or ground coffee and milk thistle extract are useful in promoting liver function and blood detoxification. Milk thistle extract contains plant chemicals called silymarin that are known for protecting the liver. Milk thistle has been identified as a source of such ingredients as silymarin, silybinin, isosilybinin, and silychristin). These agents are typically found in the seeds of milk thistle plants. Silymarin, for example, is known to protect the liver by strengthening the outer membranes of liver cells, which prevents toxins from entering the cells. Silymarin also stimulates protein synthesis in the liver, which helps to regenerate and repair the liver. Milk thistle compounds are also strong antioxidants and have bee shown to reduce damage to liver cells cause by repeated use of common prescription drugs and pollutants.

In yet another aspect, a coffee bean preparation and/or coffee ground preparation can comprise alpha-lipoic acid (ALA). Such compositions find use as antioxidants. ALA plays a role in the mitochondria of cells. ALA acts as an antioxidant, however, only when there is an excess of ALA and when it is in a free state in the cells. Typically there is little free ALA circulating in the body, unless a subject consumes supplements comprising ALA. ALA can play a role in protecting the mitochondria and the genetic material, DNA as a result of aging and oxidative damage. ALA also helps the utilization of vitamins C and E. ALA is commercially available.

The disclosure also provides a coffee composition comprising coffee beans and/or coffee ground combined with Passion Flower extract. Passion Flower (Passiflora incarnata) contains alkaloids and flavonoids which help induce sleep and relaxation. Passion flower has also been used to treat menstrual cramps. The medicinal parts of the plant are the leaves, stems, flowers and fruit. Passion Flower is a dry powdered herb deriving from Passiflora incarnata. Passion Flower has been traditionally used for it mild sedative effects; further, it advantageously has a pleasant taste and is surprisingly gentle. The plant contains a group of indole alkaloids and several flavonoids which are believed responsible for its sedative and analgesic effects. Both dried leaves and stems have been used to induce sleep, although the concentration of Passion Flower in the present dietary supplement is not enough to cause drowsiness.

The disclosure also provide coffee bean preparations and/or coffee grounds comprising ginseng. Ginseng, in which the applicable part is the root, contains ginsenosides. Ginsenosides reportedly lower blood pressure; act as an anti-hemolytic, anti-pyretic, anti-psychotic, CNS depressant and ulcer protective activity; and increase GI mobility and decreases islet insulin concentrations. When used orally, ginseng reduces post-pranial blood glucose levels in type 2 diabetics. Ginseng has also been found to lower blood glucose levels and to enhance the efficacy of vitamins C, B and E. Ginseng also acts as an adaptogen, a substance that can act to strengthen the body and increase general resistance. Ginseng has been found to protect the body and nervous system from stress, stimulate and increase metabolic function, increase physical and mental efficiency, lower blood pressure & glucose levels when they are high, and raise them (blood pressure & glucose levels) when they are low, increase gastrointestinal movement and tone, increase iron metabolism, and cause changes in nucleic acid (RNA) biosynthesis. In geriatric use, Ginseng has been proven beneficial in restoring mental abilities. For example, animal studies have demonstrated Ginseng's ability to help the learning process.

The disclosure provides a coffee composition comprising coffee beans and/or coffee ground combined with various starch blockers. Starch blockers are useful in controlling obesity by reducing the amount of carbohydrates ingested. Starch blockers consist of amylase inhibitors. In one aspect, such amylase inhibitors are made from a protein in white kidney bean (Phaseolus vulgaris). The blockers prevent the breakdown of starch molecules, which are then passed out in the feces.

In yet another aspect, the disclosure provide a coffee composition useful in controlling cortisol. Cortisol is known as a hormone which, in excess, creates stress. It is also sometimes associated with obesity (because cortisol increases appetite and stimulates adipose tissue to store fat), diabetes (because cortisol induces insulin resistance and elevates blood sugar), osteoporosis (because cortisol increases osteoclastic bone resorption and accelerates bone loss), muscle loss (because cortisol blocks the anabolic effects of testosterone and growth hormone, while also increasing protein turnover and muscle breakdown), suppressed immune system (because while short-term cortisol exposure can temporarily stimulate immune function, longer term chronic cortisol exposure accelerates immune cell death and increases risk of infections.

Cortisol is a steroid hormone made in the adrenal glands. It is essential at certain levels for proper metabolic health, but harmful if too high or to low. Among its important functions in the body include roles in the regulation of blood pressure and cardiovascular function as well as regulation of body's use of proteins, carbohydrates, and fats. Cortisol secretion increases in response to any stress in the body, whether physical or psychological. When cortisol is secreted, it causes a breakdown of muscle protein, leading to the release of amino acids into the bloodstream. These amino acids are then used by the liver to synthesize glucose for energy, in a process called gluconeogenesis. At the same time the other tissues of the body decrease their use of glucose as fuel. Cortisol also leads to the release of so-called fatty acids, an energy source from fat cells, for use by the muscles. Taken together, these energy-directing processes prepare the individual to cope with stressors and ensure that the brain receives adequate energy sources.

In one aspect, a coffee composition comprising agents that can control cortisol are provided. Substance documented to control cortisol effects include, for example, phospholipids, Beta-sitosterol, Magnolia bark, and L-Theanine. L-theanine, for example, is a relaxant that increases alpha-waves producing mental and physical relations decreasing stress and anxiety, without inducing drowsiness

The disclosure also provides a coffee composition comprising coffee beans and/or coffee ground combined with Sarsaparilla extract. Sarsaparilla is a plant of the liliaceous family which includes many varieties, depending on their origin. Representative varieties or species of which the extract can be used in the composition of the present disclosure include: Smilax aspera, Smilax officinalis, Smilax regilii, Smilax glaberrina, Smilax medica, Smilax aristolochiaefolia, Smilax papyraceae, Smilax febrifuga, Smilax ornata, Smilax saluberina and Smilax china. The sarsaparilla extract used in the composition of the disclosure can be obtained essentially from the roots of the plant. These extracts are characterized by the presence of saponins, the sapogenins of which have a steroidic structure. The sarsaparilla extract can be obtained in accordance with various processes and, principally, by maceration, digestion, decoction, infusion or lixiviation. All these extraction methods are well known and are described in detail in the book: “L'Officine”, by Dorvault, Edition Vigot, 1978, pp. 569-573. The extracts of sarsaparilla obtained by these extraction processes can be provided in the form of a liquid extract, a dry extract or an extract of soft consistency. Of the various extraction processes, one process, in accordance with the disclosure is either an aqueous extraction at the boiling point of the solvent (e.g. water), or lixiviation, using (1) at least one lower aliphatic alcohol having 1-3 carbon atoms such as methyl alcohol, ethyl alcohol or isopropyl alcohol; or (2) a mixture of water and ethyl acetate or acetone. This type extraction can be carried out at ambient temperature. Particularly, there can be used the process described in French Pat. No. 1,520,375. This process comprises treating the roots of sarsaparilla ground in the presence of methyl, ethyl or isopropyl alcohol, and concentrating the resulting product under a vacuum until it has a pasty consistency. The extract obtained is then taken up in boiling water, which is then cooled and the insoluble portion filtered off. The fraction soluble in water can then be concentrated so as to provide liquid or dry extracts or it can optionally be treated again so as to yield extracts which are more pure or which are more enriched in active substances. The soluble fraction can, in effect, be treated with ammonium sulfate and the resulting precipitate can be extracted with methanol or ethanol. After evaporation, a dry extract in the form of a powder is obtained which represents about, on a weight basis, from 8 to 10% of the total weight of the initially treated roots.

The disclosure also provides a coffee composition comprising coffee beans and/or coffee ground combined with bayberry extract. Bayberry figured as an important remedy to treat a condition that represented the physical symptoms of coldness in the body. Bayberry (Myrica cerifera, Myricaceae; also known as Candleberry, Wax Myrtle, Waxberry) has a number of similar species that can be used in the methods and compositions of the disclosure. The similar species include M. californica, Myrica gale, Myrica ocuba, and Myrica jalapensis. Bayberry contains a variety of flavonoids among which myricitrin, as well as tannins (upwards of 3.9% in the bark), terpenoids (myricadiol, taraxerol, taxaxerone), wax (containing palmitic, myristic and lauric acid esters), gums, resins, albumen and starch are the most characterized. Bayberry bark is both astringent and stimulant, highly valued in debilitated and catarrhal conditions of the mucous membranes. In small drop doses Bayberry tincture is said to have a stimulant effect upon the autonomic nervous system, “aiding the processes of digestion, blood making, and nutrition,” indicated in chronic gastritis, chronic diarrhea, mucus colitis and dysentery. In larger doses Bayberry has a decided stimulant effect upon gastric and respiratory function, best used to combat nascent fevers, colds, sore throats, flus and infectious disease.

Echinacea powder can also be combined with coffee beans and/or coffee grounds. There are three species of echinacea—E. purpurea, E. angustifolia, and E. pallida. Preparations are made from the above-ground herb (aerial) and/or root portions depending upon the species used. Echinacea sp. are good sources of phenols. For example, cichoric and caftaric acids are phenols found within both the aerial and root portions of E. purpurea, while echinacoside is a phenol found in higher levels specifically within E. angustifolia and E. pallida roots. Other constituents that may be important include alkamides and polysaccharides. The compositions of the disclosure comprising echinacea find use as immune stimulant; use in bacterial & viral infections, glandular infection, yeast infection, herpes; shortens duration of colds and flu; boost lymphatic cleansing of blood; skin eruptions; and as an anti-inflammatory for arthritis.

In yet another aspect, Black Cohosh preparations can be combined with roast coffee beans and/or coffee grounds. Black Cohosh has been shown in recent European studies to have several actions on the various symptoms associated with menopause. Certain complex chemicals, especially triterpenes and flavonoids, are believed to be the active constituents. Some of them act on the pituitary gland, which is located at the base of the brain, to suppress the secretion of luteinizing hormone (LH). High levels of LH in the blood are often associated with menopausal symptoms, including hot flashes, night sweats, headaches, heart palpitations, and drying and thinning of the vagina. In contrast to standard hormonal therapy with estrogens and progestins, however, Black Cohosh does not seem to affect levels of two other pituitary hormones, follicle-stimulating hormone (FSH) and prolactin. In other words, the action is more selective than with normal hormonal therapy. That's good, because it tends to lessen side effects. Other constituents in Black Cohosh bind to estrogen receptors, producing a weak estriol-like effect. Estriol, unlike its more potent cousin estradiol, is not associated with increased risk of breast, ovarian or endometrial cancers. Still other constituents in this plant seem to promote mild relaxation. Black Cohosh also has a tonic action on the heart and circulation. It has been experimentally proven to reduce hypertension. The plant exhibits a variety of other physiological properties that are only vaguely related to each other.

In another aspect, Cayenne preparations can be combined with roast coffee beans and/or coffee grounds. Cayenne has effects on circulation, the heart, the stomach, and other systems of the body. It is generally considered a carminative (expelling gas from the stomach & intestines) and a stimulant. The stimulant property, however, is prevalent such that increased tonus of nerves and glands is a major end result of its action. It stimulates the vital organs to greater activity levels, and promotes cardiovascular efficiency, while lowering overall blood pressure. Additionally, Cayenne acts directly as a diaphoretic, stimulating excretion of wastes in the sweat. By increasing the circulation of blood to peripheral tissues, Cayenne helps ensure that nutrients are effectively delivered to inflamed and infected areas. Cayenne also helps regulate cholesterol and lipid levels.

The disclosure provides garlic preparations combined with roast coffee beans and/or coffee grounds. Garlic has diaphoretic, diuretic, expectorant, and stimulant properties. Garlic is available in powder and ground preparations.

The disclosure provides goldenseal preparations combined with roast coffee beans and/or coffee grounds. Goldenseal, a member of the family Ranunculaceae. Goldenseal extract, derived from the rhizome and roots of plant. The coffee and goldenseal compositions of the disclosure find use as a remedy for various gastric and genitourinary disorders. Goldenseal's benefits may be attributed to its alkaloids, especially hydrastine and berberine. These alkaloids are strongly astringent and help reduce inflammation of mucous membranes. Hydrastine has also been reported to lower blood pressure and stimulate peristalsis as well as relieving cough.

Also provided are coffee compositions (e.g., ground coffee or coffee beans) comprising Hawthorne berry. This coffee compositions is useful in weight regulation and in some instances may comprise chromium picolinate. Hawthorne berry helps to offset the increased demands made on the heart by the condition of being overweight. It also helps recondition and tone-up the heart muscle while reducing body weight, especially if the weight reduction plan includes some form of routine exercise (as it should). In this case, it is very important that the heart be able to supply sufficient oxygen to the tissues in order to maintain good health. Hawthorne berries have been shown to have an oxygen-saving effect on the heart muscle. Hawthorne also exhibits a very strong vasodilatory action, and it lowers peripheral resistance to blood flow. After several hours of food abstinence, this herb produces a significant decrease in free fatty acids and in lactic acid within the body. These findings indicate that Hawthorne has an anabolic (building up) effect on the metabolic process, and helps reduce coronary stress induced by being overweight.

Certain compositions of the disclosure are also useful in eye care. The disclosure provides compositions comprising coffee beans and/or coffee grounds in combination with lutein. In some aspects the composition also includes ALA. Lutein is a yellow carotenoid pigment produced by plants, and found in macula, the small, central area covering the retina. Lutein is believed to protect the eye and optic nerves, as a filter and as an anti-oxidant. Lutein belongs to xanthophylls, a subgroup in the carotene family of plant secondary metabolism products, which consist of over 600 phytochemicals derived from C5 isoprene, known as the carotenoid pigments. These pigments give yellow, green or orange coloration to vegetables and fruits and they are precursors for Vitamin A. Lutein is naturally found in egg yolk, and several plants including some flowers, red peppers, collard greens, kale, leeks, peas, romain lettuce, mustard and spinach. In the eye, lutein is the primary carotenoid present in the central area of the retina, called macula. Lutein is thought to act as a filter to protect the light-sensitive photoreceptor cells (cone cells) in macula from potentially damaging forms of light and light-originated free radical damages. Dietary lutein is considered an essential micronutrient for normal vision. Lutein supplementation may be beneficial for the management of age-related macular degeneration, the leading cause of blindness in older people. Studies show that people who eat more lutein-containing foods appear to be less likely to develop macular degeneration.

In yet another aspect, the disclosure provides coffee preparations (e.g., coffee beans and/or coffee grounds) combined with Burdock Root. Burdock root is one of the foremost cleansing herbs, providing nourishing support for the blood, the liver, and the natural defense system. Burdock root preparations are rich in Vitamins B₁, B₆, B₁₂, and E, plus manganese, copper, iron, zinc, sulfur, and more. Burdock is also known by the names Bardane, Clotburr, Beggars Buttons, Gypsy Rhubarb, Gobo, and Burr. Medicinally, Burdock Root has been used both internally and externally for eczema and psoriasis, as well as to treat painful joints and as a diuretic. In traditional Chinese medicine, Burdock Root, in combination with other herbs, is used to treat sore throats, tonsillitis, colds, and even measles. The herb contains polyacetylenes that have both anti-bacterial and anti-fungal properties.

In yet another aspect, the disclosure provides coffee preparations (e.g., coffee beans and/or coffee grounds) comprising hyssop preparations. Hyssop, a perennial, is a native of the south of Europe, growing in meadows and moist grounds. The plant is inodorous, but has a bitter, nauseous, somewhat acrid taste, which earns it the name of Hedge Hyssop. Its active constituent is the bitter crystalline glucoside Gratiolin and a reddish, amorphous, bitter principle, Gratiosolin, likewise a glucoside. Compositions comprising hyssop and coffee are useful as diuretics. Such a composition may also be used for the relief of dropsy, scrofula, chronic affections of the liver, jaundice, and enlargement of the spleen, and as a worm dispeller. Hyssop is typically prepared from the root as a powder.

In another aspect, the disclosure provides coffee preparations (e.g., coffee beans and/or coffee grounds) comprising colostrum (e.g., non-human colostrum). Colostrum is the pre-milk fluid produced from a female's mammary glands during the first few days after birth. Bovine colostrum is derived from cows, however other non-human animals can be used as sources of colostrum including goats, sheep and the like. Colostrum is a rich source of antibodies, growth factors and nutrients for the suckling neonate and may provide passive immunity to the newborn against various infectious microorganisms, particularly those that affect the gastrointestinal tract. It may also have other health benefits. The protein content of bovine colostrum is three to four times higher than it is in regular cow's milk. The greater part of this protein is comprised of whey proteins. Immunoglobulins, mainly IgG, make up about 75% of the whey proteins. Other substances found in bovine colostrum include casein, lactoferrin, alpha-lactalbumin, beta-lactoglobulin, and the growth factors insulin-like growth factor (IGF)-1, IGF-2, transforming growth factor β (TGFβ) and epidermal growth factor (EGF). In addition, bovine colostrum contains vitamins, minerals, lipids and lactose. Bovine colostrum may also contain colostrinin, also known as proline-rich polypeptide (PRP), a substance found in ovine (sheep) colostrum. Bovine colostrum is commercially available in several forms. Bovine colostrum prepared by microfiltration is mainly composed of whey proteins and their associated immunoglobulins and the growth factors IGF-1, IGF-2, TGFβ and EGF. Substances such as lactose, fats, casein and lactalbumin are significantly reduced in microfiltered bovine colostrum. Hyperimmune bovine colostrum is rich in immunoglobulins of the IgG type, which may be protective against such infectious microorganisms as Cryptosporidium parvum (a major cause of AIDS-associated diarrhea), diarrheogenic Escherichia coli strains, Shigella flexneri, Clostridium difficile, and rotavirus, the most common cause of severe diarrhea in young children. Hyperimmune bovine colostrum is prepared from cows previously immunized with specific antigens. Hyperimmune bovine colostrum IgG concentrate is an orphan drug for the treatment of diarrhea in AIDS patients caused by infection with Cryptosporidium parvum.

In yet another embodiment, a coffee composition comprising roast coffee beans and/or ground coffee combined with Kava is provided. Kava refers to the plant and more typically the root of a shrub called the pepper plant, Piper methysticum, found in Polynesia, Melanesia, and Micronesia. The root is typically ground to a powder, and it has a brownish color. The brownish powder is then mixed with coffee grounds or may be mixed with water and used to spray coated or used in a fluidized bed process for use with coffee bean and/or coffee grounds. Kava is useful as a calming and stimulating intoxicant. Taken in large quantities it produces a euphoric state, which is why it has long been considered an aphrodisiac. Narcotic Experience in the Pacific Islands and among the Aborigines in Australia has shown that if taken to excess kava has a narcotic effect, inducing stupor. Kava has an antiseptic action and in the past it was used specifically to treat venereal disease, especially gonorrhea. Kava is useful as a urinary antiseptic, helping to counter urinary infections and to settle an irritable bladder. Kava is also useful as a remedy for chronic pain, helping to reduce sensitivity and to relax muscles that are tensed in response to pain. Accordingly, Kava compositions of the disclosure can be used in arthritic subjects and for anxiousness.

The disclosure also provides a coffee composition comprising coffee beans and/or coffee grounds combined with Astragalus extract. Astragalus boosts the immune system. Coffee compositions of the disclosure comprising astragalus can be used for conditions that can benefit from improved immune function, including acquired immune deficiency syndrome (AIDS), burns and abscesses, chronic colds and flu, fatigue, night sweats, and loss of appetite. It's also taken to counter the toxic effects of cancer treatment and to relieve the symptoms of Alzheimer's disease.

The disclosure also provides a coffee composition comprising coffee beans and/or coffee grounds combined with Black Currant Oil. Black Currant Oil is a rich source of gamma linolenic acid along with other important polyunsaturated fatty acids. Fatty acids are involved in many body functions, such as maintaining body temperature, insulating nerves, cushioning and protecting tissues and creating energy.

The disclosure also provides a coffee composition comprising coffee beans and/or coffee grounds combined with cordyceps extract or preparations. Cordyceps sinensis in its sexual stage is the primary form used. However, more than ten related species (in sexual and asexual stages) as well as artificially cultured mycelium are today used as substitutes in commercial preparations. C. sinensis, C. ophioglossoides, C. capita, and C. militaris are the most common species in commerce. Cordyceps has been used in connection with kidney disease and immune function. Cordyceps contains a wide variety of potentially important constituents, including polysaccharides, ophiocordin (an antibiotic compound), cordycepin, cordypyridones, nucleosides, bioxanthracenes, sterols, alkenoic acids, and exo-polymers.

The disclosure also provides a coffee composition comprising coffee beans and/or coffee grounds combined with quercetin. Quercetin belongs to a class of water-soluble plant pigments called flavonoids. Quercetin acts as an antihistamine and has anti-inflammatory properties. As an antioxidant, it protects LDL cholesterol (the “bad” cholesterol) from becoming damaged. A variety of evidence indicates that quercetin possesses potent antioxidant properties. Cardiologists believe that damage to LDL cholesterol is an underlying cause of heart disease. Quercetin blocks an enzyme that leads to accumulation of sorbitol, which has been linked to nerve, eye, and kidney damage in those with diabetes.

The disclosure also provides a coffee composition comprising coffee beans and/or coffee grounds combined with stinging nettle extracts. Extracts of the stinging nettle roots have been used in Germany for the therapy of prostate disorders and rheumatoid arthritis. Extracts from stinging nettle contain a number of substances including caffeic acid, malic acid, polysaccharides and probably many other compounds including lectins, lignans, and phytosterols. Stinging nettle has been shown to be anti-inflammatory by preventing the body from making inflammatory chemicals known as prostaglandins. Stinging Nettle has a valuable role to play in treating hay fever and prostate symptoms, as well as in easing the pain and inflammation of gout. Stinging nettle extract is available in powders, tinctures and aqueous extracts.

The disclosure also provides a coffee composition comprising coffee beans and/or coffee grounds combined with L-Theanine. L-Theanine, is a unique free form acid found only in the tea plant and in the mushrooms Xeroconus badius and certain species of genus Camellia, C. japonica and C. sasanqua. L-theanine is a relaxant that increases alpha-waves producing mental and physical relations decreasing stress and anxiety, without inducing drowsiness.

In some embodiments, however, non-vitamin or non-mineral functional additives are used. By non-vitamin functional additives is meant that vitamins are not separately added. For example, certain function additives including certain herbal preparations inherently include certain vitamins. By non-vitamin functional additives is meant that substantially purified vitamin preparations (e.g., substantially pure vitamin C, vitamin B, vitamin E and the like) are not separately added to a coffee composition of the disclosure. Substantially purified vitamin preparations are available commercially as Vitamin C tablets and the like.

By non-mineral functional additives is meant that minerals are not separately added. For example, certain function additives including certain herbal preparations inherently include certain minerals. By non-mineral functional additives is meant that substantially purified mineral preparations (e.g., substantially pure iron, calcium and the like) are not separately added to a coffee composition of the disclosure. Substantially purified mineral preparations are available commercially.

Non-limiting examples of vitamins and minerals, include niacin, thiamin, folic acid, pantothenic acid, biotin, vitamin A, vitamin C, vitamin B₂, vitamin B₃, vitamin B₆, vitamin B₁₂, vitamin D, vitamin E, vitamin K, iron, zinc, copper, calcium, phosphorous, iodine, chromium, molybdenum, and fluoride. A typical mineral for use is calcium. Typically at least one vitamin is selected from vitamin C, vitamin B₆, vitamin B₁₂, vitamin E, pantothenic acid, niacin, and biotin.

Commercially available vitamin A sources may be included in the compositions. As used herein, “vitamin A” includes, but is not limited to, vitamin A (retinol), β-carotene, retinol palmitate, and retinol acetate. The vitamin A may be in any form, for example, an oil, such that the vitamin composition is easily dispersed or provided to a coffee bean or coffee grounds. Where vitamin A is present in the compositions, the composition comprises at least about 1% to 100% of the U.S. Recommended Daily Intake (USRDI) of such vitamin. Typically, wherein vitamin A is included within the compositions of the disclosure, the compositions comprise from about 0.0001% to about 0.25% by weight of the product.

Commercially available sources of vitamin B₂ (also known as riboflavin) may be utilized in the coffee compositions of the disclosure. When Vitamin B₂ is present in the compositions of the disclosure, it is present at about 1% to about 100% of the USRDI of such vitamin.

Commercially available sources of vitamin C (ascorbic acid) can be used herein. For example, such available sources include edible salts of ascorbic acid. Where vitamin C is present in a coffee composition of the disclosure, the vitamin is present from about 1% to 100% of the USRDI of such vitamin. Typically vitamin C will be present from about 0.005% to about 0.25% by weight of the coffee composition.

Commercial sources of iodine may be utilized herein. Other sources of iodine include iodine-containing salts, e.g., sodium iodide, potassium iodide, potassium iodate, sodium iodate, or mixtures thereof.

Minerals which may be included in the compositions herein are, for example, magnesium, zinc, iodine, iron, and copper. Any soluble salt of these minerals suitable for inclusion in a coffee composition can be used, for example, magnesium citrate, magnesium gluconate, magnesium sulfate, zinc chloride, zinc sulfate, potassium iodide, copper sulfate, copper gluconate, and copper citrate. Calcium may be used in the compositions and methods of the disclosure. Forms of calcium include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium titrate, calcium gluconate, calcium realate, calcium tantrate, and calcium lactate, and calcium citrate-malate. Ferrous iron is typically better utilized by the body than ferric iron. Bioavailable ferrous salts that can be used in the ingestible compositions of the present disclosure are ferrous sulfate, ferrous fumarate, ferrous succinate, ferrous gluconate, ferrous lactate, ferrous tartarate, ferrous citrate, ferrous amino acid chelates, as well as mixtures of these ferrous salts. While ferrous iron is typically more bioavailable, certain ferric salts can also provide highly bioavailable sources of iron. Bioavailable ferric salts that can be used in coffee compositions of the disclosure are ferric ammonium citrate, ferric citrate, ferric saccharate, ferric sulfate, and combinations thereof. In addition to the foregoing, other source of iron are known in the art.

In addition, to the compositions of the disclosure, methods of making such compositions are also provided. The methods of the disclosure are useful in preparing functionalized coffee bean compositions and functionalized coffee ground compositions. Such compositions are useful to produce coffee drinks and provide health benefits to subject that consume the drinks.

Coffee beans are first roasted by methods standard in the industry. Any coffee bean may be used, and various roasting equipment and processes well known in the coffee arts may be employed.

In another aspect, the coffee beans are first roasted by methods standard in the industry and ground in any conventional manner to provide a particulate, ground coffee. Various roasting and grinding equipment and processes well known in the coffee arts may be employed. Typically whole coffee beans are ground in a plate grinder with a resulting particle size distribution as follows. Using Tyler screens, approximately 8% is retained on a #8 sieve, approximately 65% is retained on a #28 sieve, with approximately 27% passing through as a fine powder.

The functional additives employed in the disclosure may be provided as a powder or particulate compositions. In some embodiments, the functional additives are soluble in water or other biocompatible solvent. Where functional additives are obtain they may be converted into powders using conventional grinders or mills. Typically the functional additives are reduced to powders having a size range of less than 100 microns, and more typically in the range of 20 to 70 microns.

Where coffee beans are to be “functionalized” a preparation of at least one non-vitamin, non-mineral functional additive is prepared in a soluble or dispersed form in a solvent (e.g., water or propylene glycol). The solvent comprising the functional additive is the spray coated or dispersed onto roast coffee beans. The functional additive may be provided to the beans under conditions that allow absorption of the functional additive into or onto the bean. One or more mineral and/or vitamin additives may also be coated or sprayed onto the coffee beans. The roast coffee beans are allowed to dry under appropriate conditions and then packaged.

When ground coffee is used, the ground coffee and at least one non-vitamin, non-mineral functional additive in powdered form is mixed to provide a substantially homogeneous coffee-blend. One or more mineral and/or vitamin additives may also be mixed into the ground coffee. This mixing may be achieved in any conventional food mixer suitable for use with particulate and powdered materials. In one aspect, a fluidized bed technique may be used. The dry powdered functional additives and ground coffee should be mixed shortly after the coffee beans are ground to take advantage of the ground coffee's natural oils which may act to bind the coffee grounds and powdered vitamins. In addition, the oils upon heating assist in the chemical availability of some functional additives assisting the bodies ability to assimilate the functional additive in a way that speeds the desired effect and enhances the net available effect of the active ingredients. In some areas of health science this is called an “Enhanced Messaging Effect” associated with a functional additive.

In another embodiment, the specific gravity, weight, and/or particle size of the ground coffee is matched with that of the powdered functional additives to provide a substantially homogenous mixture and to help prevent settling and separation of the individual constituents during shipment and storage. Once the ground coffee comprising the functional additive is prepared, the mixture is packaged using any conventional packaging technique. Typically the packaging will create a vapor seal to maintain freshness.

In another aspect of the disclosure a fluidized bed technique is used to combine one or more functional additives with coffee beans and/or coffee grounds. Significant amounts of solid materials are processed using fluid-bed technology. Suspension and movement of particles in an airstream maximizes the exposure of particle surfaces to air or gas, producing efficient evaporation.

Typical batch fluid-bed processors are used to perform drying, agglomeration, mixing, and coating operations. Sophisticated controls, computer systems that monitor process parameters, and air handlers equipped with temperature and humidity controls are some of the innovations that have increased the range of applications for batch fluid-bed processing.

A fluidized bed is a bed of solid particles with a stream of air or gas passing upward through the particles at a rate great enough to set them in motion. An expanded bed is formed when the gas or airflow rate increases and particles move apart. A few visibly vibrate and move about in restricted regions. At still higher velocities of airflow, all the particles become suspended. At this point, the frictional force between a particle and air balances the weight of the particles, the vertical component of the compressive force between adjacent particles disappears, and the pressure drop through any section of the bed approximates the weight of air and particles in that section. The bed is referred to as an incipiently fluidized bed or a bed at minimum fluidization.

As the air travels through the particle bed, it imparts unique properties to the bed. For example, the bed behaves like a liquid. It is possible to propagate wave motion, which creates the potential for improved mixing. The surface area of fluidized particles is large, which improves heat transfer, reduces process time, and imparts reproducible operating parameters. Thus, the fluid bed can be used to agglomerate particles, improve flow properties, instantize the product, produce coated particles, pellets, or tablets, taste-mask bitter products, or effect uniform chemical reactions in a controlled fashion.

When particles, beads, or tablets enter the high-velocity spout, they are uniformly accelerated and physically separated from each other. As the high-velocity air and the particles move up, the coating is applied by a spray nozzle mounted at the base of the spout. The process air that moves the particles also serves to dry the coating. Because of the large amounts of air used, excellent drying is achieved by this process. When the airstream and particles clear the top of the partition, the air in the spout spreads out to fill the expansion chamber, and the particles settle out on the top of the bed of fluidized particles. Because the bed of particles is fluidized by air, additional drying occurs as the particles descend to the bottom of the bed and reenter the partition, where they are accelerated again by the high-velocity airstream and receive additional coating.

In some instances heated air is used to dry the product. During the drying, agglomerating, and coating processes, the drying capacity of the air must be carefully monitored to preserve the natural oil content inherent in freshly ground coffee.

To move air in a fluid bed, blowers or exhaust fans mounted outside of the processing area impart motion and pressure to the air using a paddle-wheel action. The moving air acquires a force or pressure component in its direction of motion because of its weight and inertia. This force is called velocity pressure and is measured in inches or millimeters of water column. In operating duct systems, a second pressure that is independent of air velocity or movement is always present. Known as static pressure, it acts equally in all directions. In exhaust systems (such as fluid beds), a negative static pressure will exist on the inlet side of the fan. Total pressure is the combination of static and velocity pressures.

Airflow in coating a coffee bean composition and/or coffee grounds (i.e., substrate) can be performed in fluid-bed equipment using a top spray, a bottom spray with a Wurster column, or a rotary coater. The coating process involves the deposition of droplets on the substrate material, followed by spreading and coalescing of the droplets, which form a continuous layer as they adhere to the matrix. Throughout the process, solvent is evaporating.

The disclosure also provides methods and compositions for preparing a functionalized coffee at a point of purchase. A point of purchase can be a store or any other commercial vendor (e.g., a café or other coffee shop). The disclosure also contemplates on-line ordering of functionalized coffee beverages/drinks via the Internet. In these point of purchase embodiments, a customer will identify a functional additive from a menu. The customer will also identify a coffee bean or ground coffee type (e.g., a flavored coffee, a decaffeinated coffee and the like). An employee will then select the identified functional additive and/or coffee-type and prepare a functionalized coffee composition by grinding the coffee bean to provide coffee grounds. The employee combines an appropriate amount of a functional additive (e.g., from about 0.01% to 20% (e.g., 0.1% to 15%) by weight of the functional additive with the coffee ground and mix the functional additive and the coffee grounds to provide a substantially homogenous mixture to obtain a functionalized coffee composition. The employee may than package the functionalized coffee composition or extract the functionalized coffee preparation by brewing the preparation under standard brewing temperatures and techniques to obtain a functional coffee drink.

The disclosure also includes functionalized coffee beverages or drinks. The functionalized coffee beverages or drinks are obtained by extraction (i.e., brewing) of ground coffee comprising a functional additive. The functionalized coffee beverage or drink may be packaged in cans or bottles.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. A composition, comprising:
roasted coffee beans or ground coffee from roasted coffee beans; and about 0.01% to 20% by dry weight L-theanine.

2. The composition of claim 1, further comprising one or more non-vitamin, non-mineral functional additives selected from the group consisting of an amino acid, methyl-sulfonyl-methane (MSM), green tea or green tea extract, dimethylaminoethanol (DMAE), alpha-lipoic acid, lutein preparations, white willow bark preparations, ginger preparations, colostrum, a phytosterol, beta-sitosterol, a phytostanol, passion flower preparations, ginseng preparations, sarsaparilla preparations, bayberry root preparations, echinacea powder, burdock root preparations, goldenseal root preparations, kelp preparations, hyssop preparations, milk thistle preparations, astragalus preparations, black-currant oil, cordyceps preparations, quercetin, stinging nettle preparations, and tumeric preparations.

3. The composition of claim 2, wherein the one or more functional additives is a ginseng preparation.

4. The composition of claim 1, further comprising at least one vitamin.

5. The composition of claim 3, wherein the at least one vitamin is selected from the group consisting of niacin, thiamin, folic acid, pantothenic acid, biotin, vitamin A, vitamin C, vitamin B2, vitamin B6, vitamin B12, vitamin D, vitamin E, and vitamin K.

6. The composition of claim 4, wherein the at least one vitamin is selected from vitamin C, vitamin B6, vitamin B12, vitamin E, pantothenic acid, niacin, and biotin.

7. The composition of claim 4, wherein the at least one vitamin is selected from the group consisting of thiamin, folic acid, pantothenic acid, vitamin B2, vitamin B3, vitamin B6 and vitamin B12.

8. The composition of claim 2, further comprising at least one vitamin selected from the group consisting of niacin, thiamin, folic acid, pantothenic acid, biotin, vitamin A, vitamin C, vitamin B2, vitamin B6, vitamin B12, vitamin D, vitamin E, and vitamin K.

9. The composition of claim 1, further comprising at least one mineral.

10. The composition of claim 9, wherein the at least one mineral is selected from the group consisting of iron, zinc, copper, calcium, phosphorous, iodine, chromium, molybdenum, and fluoride.

11. The composition of claim 1, further comprising one or more non-vitamin, non-mineral functional additives that are herbals and herbal derivatives selected from among agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, cascara sagrada, catnip, celery, centaury, chamomile, chaparral, chickweed, chicory, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, garlic, gentian, ginger, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. Johnswort, sarsaparilla, sassafras, saw palmetto, scullcap, senega, senna, shepherd's purse, slippery elm, spearmint, spikenard, squawvine, stillingia, strawberry, taheebo, thyme, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca and combinations thereof.

12. The composition of claim 2, further comprising one or more non-vitamin, non-mineral functional additives that are herbals and herbal derivatives selected from among agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, cascara sagrada, catnip, celery, centaury, chamomile, chaparral, chickweed, chicory, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, garlic, gentian, ginger, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. Johnswort, sarsaparilla, sassafras, saw palmetto, scullcap, senega, senna, shepherd's purse, slippery elm, spearmint, spikenard, squawvine, stillingia, strawberry, taheebo, thyme, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca and combinations thereof.

13. The composition of claim 11, wherein the one or more functional additives are selected from among bee pollen, chicory, damiana, ephedra, ginseng, gotu kola, hops, lemon grass, licorice, lobelia, mandrake, oatstraw, passion flower, rose hips, rosemary, St. Johnswort, sarsaparilla, sassafras, scullcap, valerian, yerba santa and combinations thereof.

14. The composition of claim 11, wherein the functional additive is chamomile.

15. The composition of claim 12, wherein the functional additive is chamomile.

16. The composition of claim 1, wherein the one or more functional additives are spray coated onto roasted coffee beans or ground coffee from roasted coffee beans.

17. The composition of claim 1, wherein the roasted coffee beans are dip-coated into a solvent comprising the one or more functional additives and dried.

18. The composition of claim 1, wherein the roasted coffee beans are coated with the one or more functional additives by fluid bed processing.

19. The composition of claim 1, wherein the ground coffee and L-theanine in powdered form is mixed to provide a substantially homogeneous blend.

20. A package, comprising the composition of claim 1.
